(19) United States
(12) Patent Application Publication
(10) Pub. No.: US 2015/0183644 A1
(43) Pub. Date: Jul. 2, 2015

(54) METHOD OF PRODUCING ACTIVATED CARBON FROM BAMBOO SCAFFOLDING WASTE, WASTE WOODEN PALLET AND THE LIKE AND THE APPARATUS THEREFOR

(71) Applicant: Scion Energy (Hong Kong) Limited, Hong Kong (HK)

(72) Inventors: Jiemund SIU, Hong Kong (HK); King Lung LEE, Hong Kong (HK); Gordon MCKAY, Hong Kong (HK)

(21) Appl. No.: 14/583,807

(22) Filed: Dec. 29, 2014

(30) Foreign Application Priority Data
Dec. 31, 2013 (HK) 13114411.7

(51) Int. Cl. C01B 31/10; B01J 19/00; B01J 19/28

(52) U.S. Cl. CPC C01B 31/10; B01J 19/28; B01J 19/006; B01J 2219/00081; B01J 2219/00763

(57) ABSTRACT

This invention discloses an apparatus and a method for producing activated carbon with high quality from feedstock of bamboo scaffolding waste, waste wooden pallets and the like. The apparatus is an indirect heated rotary kiln comprises a rotary shell; at least one heating tube adapted to be fixedly positioned inside said rotary shell; and at least one activation agent injection pipe adapted to be fixedly positioned within the stationary heating tube. The method is characterized in having part of the fuel gas generated in the carbonization process stored in the indirect rotary kiln before being delivered to a furnace for combustion. The method is further characterized in having the activation agent heated inside the furnace prior to a further heating inside the heating tube. After this further heating, the activation agent is injected into the reactor and activates the char therein. Excess and unreacted activation agent and synthesis gas generated through the activation process are mixed with the fuel gas inside the reactor and the mixture will then be sent back to the furnace for combustion to generate heat and energy to sustain the activation process.

### CROSS-REFERENCE TO RELATED APPLICATION

This application claims benefit under 35 U.S.C. §119(e) of Hong Kong Short Term Patent Application having Serial No. 13114411.7 filed on Dec. 31, 2013, which is hereby incorporated by reference herein in its entirety.

### FIELD OF INVENTION

This invention relates to a method and an apparatus for producing activated carbon from feedstock of bamboo scaffolding waste, waste wooden pallet and the like; in particular, the bamboo scaffolding waste, waste wooden pallet and the like undergo carbonization and activation processes in a novel reactor.

### BACKGROUND OF INVENTION

Nowadays, in Hong Kong, there is problem with the treatment of bamboo scaffolding waste and wooden pallet. Bamboo scaffolding waste is classified as construction waste in Hong Kong and charged for 125 Hong Kong dollars per ton for landfill disposal in year 2011. Besides, Hong Kong is a famous logistic center of the world. Wooden pallets are transported to Hong Kong with cargoes and containers. However, due to the lack of wooden pallet fumigation and/or heat treatment facilities in Hong Kong, the used wooden pallets cannot be exported or re-exported to other countries. Thus, huge amount of wooden pallets are dumped to landfill in Hong Kong every year. One of the attractive ways to tackle the problem of bamboo scaffolding waste and waste wooden pallets is to upgrade the bamboo scaffolding waste and waste wooden pallets to activated carbons.

Activated carbons are extensively used to purify, decolorize, deodorize, dechlorinate, and detoxicate potable waters; for solvent recovery and air purification in inhabited spaces, food-processing, and chemical industries; in the purification of many chemical and foodstuff products; and in a variety of gas phase applications. Activated carbons have also been increasingly used in hydrometallurgy for the recovery of gold, silver, and other inorganics in the treatment of domestic and industrial wastewaters. Thus, activated carbons are of interests in many economic sectors and concerned industries as diverse as food processing, pharmaceuticals, chemicals, environmental, petroleum, mining, nuclear, automobile, and vacuum manufacturing.

Traditionally, the manufacture of activated carbons involves two main steps: the carbonization of the carbonaceous material at temperatures below 800° C. in the absence of oxygen and the activation of the char formed from carbonization.

Carbonization, also referred to as pyrolysis, involves thermal decomposition of carbonaceous raw material to produce char by eliminating non-carbon species and producing a fixed carbon mass and a basic pore structure. Carbonization is usually carried out in indirect heated rotary kiln or multiple hearth furnaces at temperatures below 800° C. in an inert environment. The important parameters that determine the quality and the yield of char are the rate of heating, the final temperature, the soaking time of char at the final temperature, and the nature and physical state of the carbonaceous raw material.

A number of methods and apparatuses are known for converting the carbonaceous raw materials into char. US patent publication no. US2002/0159931A1 and European patent publication no. EP1,207,190A2 provide information on how the process parameters can affect the products of the carbonization process. European patent publication no. EP1,207,190A2 discloses a reactor in which combustion and carbonization take place in a same carbonization unit. The heat produced from the combustion can be used directly to provide energy for the carbonization in the same carbonization unit; however, the combustion inside the carbonization unit decreases the yield of char. Chinese patent publication no. CN201626934U discloses an indirect rotary kiln system to carbonize biomass, in which the indirect rotary kiln system includes an indirect rotary kiln preheater and an indirect rotary kiln carbonizer. The indirect rotary kiln system is further characterized in having the indirect rotary kiln system fueled by the organic vapors generated during the carbonization process of the biomass. Chinese patent publication no. CN102226092 discloses a method and apparatus for continuous carbonization of biomass, in which the method and apparatus disclosed therein is characterized in having a complicated flue gas pathway to increase the energy efficiency of the carbonization system. US patent no. U.S. Pat. No. 5,769,007 disclosed a low temperature carbonization drum which has an interior receiving bulk material or trash and a longitudinal axis about which the heating chamber or drum is rotatable. Unlike most of the indirect heated rotary kiln, the high temperature media of the low temperature carbonization drum is not flowing outside the rotary drum. Instead, the rotary drum comprises a number of heating tubes, through which a heating gas can flow in a given direction, are disposed in the interior of the heating chamber or drum and oriented approximately parallel to one another. The heating tubes have an end region in the given flow direction; as such, the heating gas flows inside the heating tubes and rotate together with the rotary drum. Furthermore, turbulators are disposed inside the heating tubes in the end region.

The aforementioned technologies only disclose the methods and apparatuses to produce char from carbonaceous raw material. The char has only a weakly developed porous structure in which in absence of additional activation, the char cannot be used in practice as activated carbon. The activation process is to enhance the volume and enlarge the diameters of the pores that were created during the carbonization process and to create some new porosity. The structure of the pores and the pore size distribution are largely predetermined by the nature of the raw material and the process of carbonization. Activation removes disorganized carbon, exposing the aromatic sheets to the action of activation agents in the first step, and leading to the development of a microporous structure. Different from carbonization, activation requires more rigorous conditions. Normally, the temperature required for activation is higher than 600° C.; under normal conditions, the temperature is within the range of 800° C. to 1000° C. In this case, traditional indirect heated rotary reactor or traditional indirect heated rotary kiln can hardly be used as activation reactor. This is because the mechanical strength of commonly used material of the rotary drum of the traditional indirect heated rotary reactor or traditional indirect heated rotary kiln, including iron, steel and common stainless steels, drops significantly at temperature higher than 800° C. The drop of mechanical strength of commonly used material poses process safety issues of operating the activation reactor. The selection of high grade stainless steel, including SS309, SS310 and SS321, and super alloy for manufacturing of the rotary drum make the capital investment too high to be economically feasible. As a result, traditional indirect heated rotary kiln is seldom used for being the activation reactor. Instead, other types of reactors are used.

In PCT publication no. WO00/71936, a fixed bed reactor is used as the activation reactor. The problem associated with a fixed bed reactor is the relatively uneven heating of the char bed and the quality of the activated carbon may not be constant. In PCT publication no. WO2007/097600, a direct heated rotary kiln is used as the activation reactor. With the direct heated rotary kiln, the rotary drum of the indirect heated rotary kiln can be made from concrete instead of metals, including steel, stainless steel, etc., which can solve the problem introduced by high activation temperature. However, with a fire inside the reactor, there is high possibility of having the char combusted and the oxygen in the flue gas of the burner will be in contact with the char. As a result, the activated carbon yield of the system disclosed in that PCT publication should not be good. Chinese patent publication CN101164877A discloses an activated carbon production system which utilizes another common type of activation reactor, fluidized bed reactor. The activated carbon production system comprises a circulating fluidized bed carbonizer and bubble bed fluidized bed activation reactor. Chinese patent number CN1587036A, CN1333180A and Taiwanese patent number TW1227331B also disclose some other methods to produce activated carbon from different types of biomass.

Basically, most of the activated carbon production technologies involve separated apparatus for carrying out carbonization and activation. This implies a more complicated process design and, possibly, a longer production lead time. As such, there exist some inventions that attempt to integrate the apparatus for carbonization and apparatus for activation. Chinese patent number CN101085677 disclosed a method to operate a fixed bed kiln to produce activated carbon from bamboo. This method allows combustion to occur at the entrance door of the fixed bed kiln in order to provide heat to carbonize the bamboo into bamboo char inside the kiln. Then, the entrance door of the kiln is opened to introduce a more rigorous combustion inside the kiln. When the temperature of the kiln is kept in the range of 700° C. to 1000° C. for more than 1 hour, activation agent is injected into the kiln to activate the bamboo char inside the fixed bed kiln. Again, allowing combustion inside the fixed bed kiln implies a loss of activated carbon yield and the uneven product quality due to uneven heating. Chinese patent number CN2900492Y disclosed an apparatus that served a similar function to that disclosed in Chinese patent number CN101085677, but instead of using the entrance door of the kiln, the kiln of the Chinese patent number CN2900492Y uses a blower to control the temperature of the kiln, wherein the kiln comprises an activation chamber and a carbonization chamber. Japanese patent no. JP11278822A disclosed an apparatus that utilized a moving bed reactor to produce activated carbon continuously. The feedstock is fed from the top of the reactor; then by going down the reactor as a bed, the feedstock undergoes drying, devolatilization, combustion, carbonization and activation in different layers to yield activated carbon. In the middle of the reactor, the volatile matter generated from the devolatilization mixed with air and combustion occurs. The carbonization layer is right below the devolatilization layer and thus the combustion would probably decrease the yield of the activated carbon. Furthermore, although the bed moves downward, there is no adequate mixing of the activation agent and the char produced by the carbonization layer in the activation layer. Thus, the efficiency and product quality may not be good. Chinese patent no. CN1876566A disclosed a method of producing activated carbon from biomass. Unlike traditional method which requires combustion of fuel to produce heat and energy for carbonization and activation, the method utilizes microwave to carbonize the biomass and activate the biomass char simultaneously.

It is worth to mention that activation involves the following chemical reaction:

aC+bH₂O→cCO+dH₂+eCO₂+Volatile Matters Chemical Equation I

The reaction alone may be endothermic, depending on the yield of each of the reaction products, thus, it is the traditional idea that additional energy must be needed for the activation process. As a result, it is commonly disclosed in prior art that part of the char or external fuel is combusted for provision of energy to proceed with the activation. However, the combustion of H₂, CO and volatile matters in the Chemical Equation I leads to the following reactions as described in the equations below:

cCO+Volatile Matters+fO₂→gH₂O+hCO₂ Chemical Equation II

On combining Chemical Equations I and II, we have:

aC+bH₂O+fO₂→(e+h)CO₂+gH₂O Chemical Equation III

By balancing, the overall chemical equation should then be:

C+aO₂→CO₂ Chemical Equation IV

The chemical reaction as specified by Chemical Equation IV is exothermic. As such, if all synthesis gas produced from the activation process can be combusted for generation of energy and energy recovery from flue gas can be significant, then, the activation should be self-sustainable. However, one skilled in the art has never tried to investigate the combustion of the synthesis gas produced by the activation process, nor has the aforesaid process been ever disclosed in any prior art. This may be due to the fact that the synthesis gas contains high content of activation agent, and thus it is difficult to ignite the synthesis gas.

Another problem associated with the activated carbon production from biomass is the emission of volatile organic matters in both carbonization and activation processes. Such emission is always a threat to the environment. The collection of fuel gas and synthesis gas for the use as fuel of the system is a way to tackle the problem; however, in Hong Kong, process involving condensation of fuel gas in the carbonization process is categorized as an oil refinery process that requires complicated environmental impact assessment process.

Thus, this is the objective of the present invention to solve the problem that cannot be resolved by any methods and/or apparatuses disclosed in any prior art. This problem includes separated carbonization and activation reactors that introduce bigger heat loss, higher investment and possibly longer production lead time; inadequate mixing of char and activation agent during the activation process that causes inconsistent quality of activated carbon produced; partial combustion of char that decreases the final yield of activated carbon; and treatment of fuel gas that may cause the problem of low energy efficiency and complicated environmental impact assessment process.

### SUMMARY OF INVENTION

In the light of the foregoing background, it is an object of the present invention to provide an alternate apparatus for carbonization and activation of bamboo scaffolding waste, waste wooden pallets and the like, and an alternate method for producing activated carbon from bamboo scaffolding waste, waste wooden pallets and the like.

Accordingly to a first aspect of the present invention, there is provided an apparatus for carbonization and activation of feedstock of bamboo scaffolding waste, waste wooden pallets and the like to produce activated carbon with high quality. The apparatus is an indirect heated rotary kiln comprises a rotary shell in which a reactor cavity is created therewithin; at least one heating tube adapted to be fixedly positioned inside the rotary shell; and at least one activation agent injection pipe adapted to be fixedly positioned within the heating tube. At least one activation agent injection pipe opening is located on the stationary heating tube. The bamboo scaffolding waste, waste wooden pallets and the like are placed between the rotary shell and the heating tubes to undergo the carbonization and activation processes.

In addition, a first portion of a first devolatilization product is adapted to retain within said kiln for further mixing and reacting with synthesis gas produced from activation of a second devolatilization product to supply heat for the devolatilization. In an exemplary embodiment, both devolatilization and activation of the feedstock can be carried within the indirect rotary kiln. In a further embodiment, a second portion of the first devolatilization product is adapted to be directed out of the kiln to a furnace to supply heat for said devolatilization.

In another aspect of the present invention, a method for producing activated carbon from bamboo scaffolding waste, waste wooden pallets and the like is provided, in which the bamboo scaffolding waste, waste wooden pallets and the like undergo devolatilization and activation processes in a single reactor. The fuel gas generated in the devolatilization process is combusted to provide heat and energy to sustain the carbonization and activation processes. Excess fuel gas is stored in the reactor before being transferred to a combustion chamber for combustion. This allows the fuel gas to be further carbonized inside the reactor to increase the yield of the activated carbon. Activation agent is heated inside the combustion chamber prior to a further heating by the combustion flue gas. The activation agent is injected into the reactor and activates the char therein. Excess and unreacted activation agent and synthesis gas generated through the activation process are mixed with the fuel gas inside the reactor and the mixture will then be sent back to the furnace for combustion to generate heat and energy to sustain the activation process.

### BRIEF DESCRIPTION OF FIGURES

A preferred embodiment of the present invention is described, by way of example only, in conjunction with the accompanying drawings wherein like reference numerals designate like parts throughout the specification, in which:

FIG. 1 shows a schematic diagram of an indirect rotary kiln used for the production of activated carbon according to a preferred embodiment of the present invention.

FIG. 2 is a schematic diagram of the cross-sectional views of indirect rotary kilns used for the production of activated carbon according to a preferred embodiment of the present invention.

FIG. 3 shows a schematic diagram of a method for production of activated carbon using a reactor according to a preferred embodiment of the present invention.

### DETAILED DESCRIPTION OF THE PREFERRED EMBODIMENTS

As used herein and in the claims, “comprising” means including the following elements but not excluding others.

The present invention is directed to a method and an apparatus for producing activated carbon from bamboo scaffolding waste, waste wooden pallets and the like, in which the bamboo scaffolding waste, waste wooden pallets and the like undergo carbonization and activation processes in a novel reactor. The novel reactor is an indirect rotary kiln comprising at least one heating tube, a rotary shell, and at least one activation agent injection pipe. The indirect rotary kiln is characterized in having the heating tube fixedly positioned inside the rotary shell and the stationary activation agent injection pipe positioned inside the fixed heating tube. The bamboo scaffolding waste, waste wooden pallets and the like are placed between the rotary shell and the heating tube to undergo the carbonization process at the beginning of the operation. The rotary shell then starts rotating and high temperature media starts flowing inside the heating tube so as to heat up the bamboo scaffolding waste, waste wooden pallets and the like inside the indirect rotary kiln. The bamboo scaffolding waste, waste wooden pallets and the like inside the indirect rotary kiln undergoes carbonization process to form char and fuel gas while the temperature inside the indirect rotary kiln continues to rise. The fuel gas is combusted in a furnace to provide heat and energy to sustain the carbonization process. Excess fuel gas is stored inside the reactor before being transferred to the furnace for combustion. This allows fuel gas to be further carbonized inside the indirect rotary kiln to increase the yield of the char from the carbonization process. When the temperature of the indirect rotary kiln reaches a predetermined temperature, activation agent is heated inside the furnace prior to a further heating by the high temperature media. The activation agent is then injected into the reactor and activates the char produced by the carbonization process. Excess activation agent and synthesis gas generated through the activation process are mixed with the fuel gas that stored inside the indirect rotary kiln and the mixture is then sent back to the furnace for combustion to provide energy and heat to sustain the activation process. After an activation duration, the bamboo scaffolding waste, waste wooden pallets and the like inside the indirect rotary kiln is changed to activated carbon with high quality. The indirect rotary kiln is then cooled down for the unloading of the high-quality activated carbon.

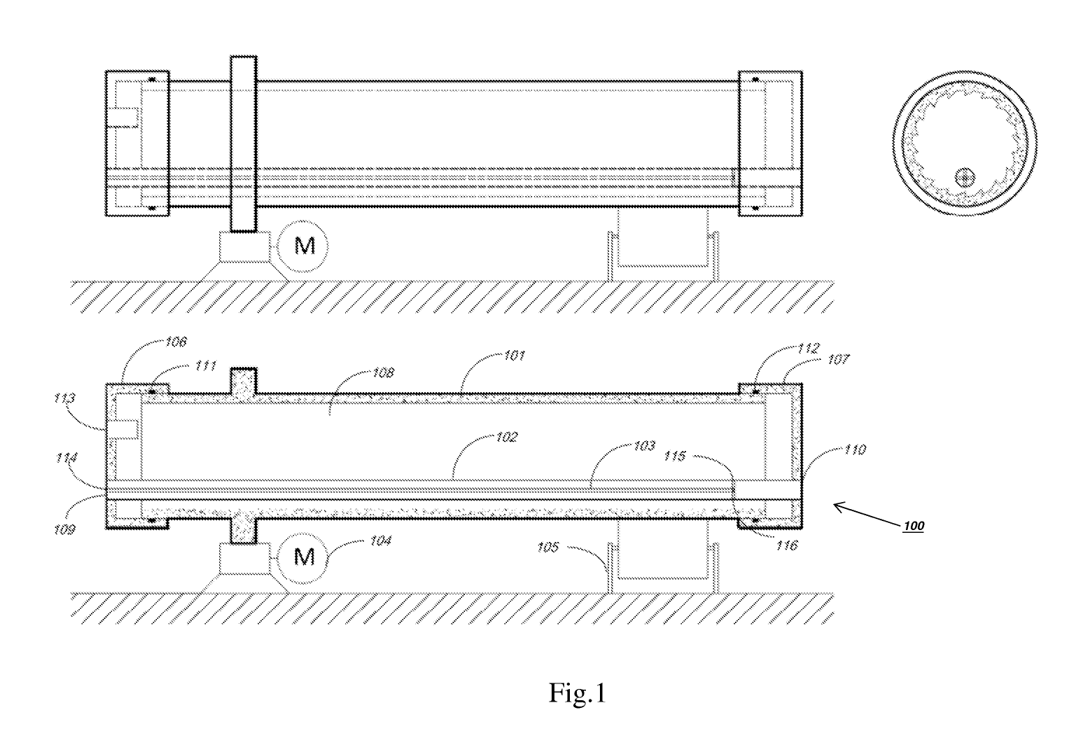

FIG. 1 shows a schematic diagram of an indirect rotary kiln for producing activated carbon from bamboo scaffolding waste, waste wooden pallets and the like. Referring to FIG. 1, the novel activation reactor is an indirect rotary kiln 100 comprising a rotary shell 101, a stationary heating tube 102 positioned inside the rotary shell 101, a stationary activation agent injection pipe 103 positioned inside the heating tube 102, and a plurality of supporting wheels 105 positioned below the rotary shell 101 for the purpose of supporting the rotary shell 101 during operation, and a motor 104 installed on the periphery of the rotary shell 101 in proximity to a stationary front end 106. As shown in the embodiment of FIG. 1, the rotary shell 101 is cylindrical in shape. A reactor cavity 108 is provided within the rotary shell 101 and bounded by the stationary front end 106 and a stationary back end 107. A feedstock opening is provided at each of the front end 106 and the back end 107.

Within the activation reactor, a first portion of a first devolatilization product is adapted to retain within said kiln for further mixing and reacting with synthesis gas produced from activation of a second devolatilization product to supply heat for said devolatilization.

During the operation of the indirect rotary kiln described above, raw materials of bamboo scaffolding waste, waste wooden pallets and the like are first loaded into the reactor cavity 108 through either of the feedstock openings at the front end 106 or the back end 107. Upon loading, the opening is closed and the motor 104 is switched on to rotate the rotary shell 101 at a controllable rotation speed. In one embodiment, the rotation speed is in the range of 0.2-1 revolution per minute. High temperature media is then flown into the heating tube 102 either at the front end tube opening 109 or at the back end tube opening 110 for heating up the contents in the reactor cavity 108. After the content in the reactor cavity 108 is heated up, the high temperature media is flown out of the indirect rotary kiln 100 through the front end opening 109 if it is flown into the heating tube 102 from the back end opening 110, or is flown out of the indirect rotary kiln 100 through the back end opening 110 if it is flown into the heating tube 102 from the front end opening 109. With such arrangement, the high temperature media is only in contact with the fixed parts, including the front end 106 and the back end 107 of the indirect rotary kiln 100.

The rotary shell 101 is made of material with good insulation property instead of highly conductive materials used for conventional indirect rotary kiln, such that the temperature of the reactor cavity 108 can be maintained. In addition, the sealants 111, 112 are not positioned at the hottest surface of the rotary kiln 101, which is on the heating tube 102, but at the coolest part of the reactor, so as to solve the problem of using conventional indirect rotary kiln in which conventional indirect rotary kiln needs to be operated at a temperature higher than 800° C. throughout the activation process of the char.

When the temperature of the reactor cavity 108 continues to rise after the injection of high temperature media into the heating tube 102, bamboo scaffolding waste, waste wooden pallets and the like are devolatilized to evolve a first devolatilization product and a second devolatilization product. In one embodiment, the first devolatilization product is volatile matters while the second devolatilization product is char. A second portion of the volatile matters is directed out of the indirect rotary kiln 101 via a volatile matter outlet 113 at the front end 106 for combustion. The combustion of these vented volatile matters is set to generate heat enough for the continuous and steady increment of the temperature of the reactor cavity 108. The amount of volatile matters vented out of the indirect rotary kiln 101 is regulated. The remaining part of the volatile matters is intentionally trapped within the reactor cavity 108 and reserved for further reactions in increasing the yield of char from the carbonization process, so as to increase the final yield of activated carbon.

When the temperature of the reactor cavity 108 reaches an activation agent injection temperature, preferably in the range of 750-800° C., high temperature activation agent is injected into the activation agent injection pipe 103 via the activation agent injection pipe opening 114. As aforementioned, the activation agent injection pipe 103 is positioned inside the heating tube 102 so that high temperature activation agent can be further heated along the activation agent injection pipe 103 by the high temperature heating medium flowing inside the heating tube 102. The high temperature activation agent is then injected into the reactor cavity 108 at the activation agent outlets 115, 116 wherein the activation agent activates the contents in the reactor cavity 108. During activation, the high temperature activation agent reacts with char for the generation of synthesis gas. In one embodiment, the synthesis gas comprises methane, carbon monoxide, carbon dioxide, and short chain hydrocarbons. The synthesis gas is then mixed with a first portion of the volatile matters trapped within the reactor cavity 108 to increase the heating value and decrease the lower explosive limit and the auto ignition temperature of the synthesis gas. The trapping of the mixture of synthesis gas and the first portion of the volatile matters within the reactor cavity 108 helps to resolve the problem encountered in conventional indirect rotary kiln in which it is often difficult to bring the synthesis gas generated from the activation process into combustion.

Later on, when the temperature of the reactor cavity 108 reaches an activation completion temperature for an activation duration, the activation process is then completed. In one embodiment, the activation completion temperature is in the range of 800-1000° C. while the activation duration is in the range of 0.5-4 hours. The pressure of the reactor cavity 108 is then allowed to settle to atmospheric pressure and thus, most of the synthesis gas and the volatile matters trapped in the reactor cavity 108 are displaced by the high temperature activation agent. Room temperature air is then directed into the heating tube 102 for cooling down the content within the reactor cavity 108. When the temperature of the reactor cavity 108 reaches a room-temperature-air injection temperature, the room temperature air can also be directly injected into the reactor cavity 108 through the activation agent injection pipe 103. In one embodiment, the room temperature air injection temperature is in the range of room temperature to 300° C. During the cooling process, the rotary shell is kept rotating so as to speed up the cooling process by improving the heat transfer rate. When the temperature of the reactor cavity 108 is below 150° C., activated carbon with high quality generated in the reactor cavity 108 can be unloaded therefrom for storage.

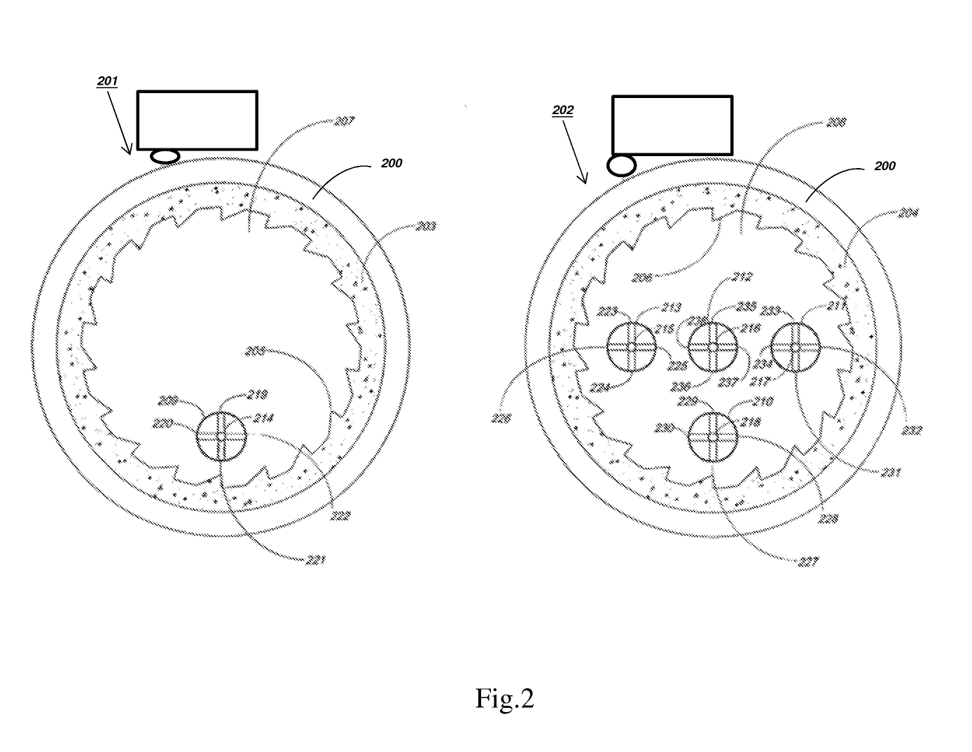

FIG. 2 illustrates the cross sectional views of two different configurations 201, 202 of the indirect rotary kiln that is used for the production of activated carbon according to one of the preferred embodiments of the present invention. The main differences between these two configurations 201, 202 are that there are more heating tubes (one heating tube 209 in the configuration 201; and four heating tubes 210, 211, 212, 213 in the configuration 202) and activation agent injection pipes (one activation agent injection pipe 214 in the configuration 201; and four activation agent injection pipes 215, 216, 217, 218 in the configuration 202) in the configuration 202 than those of the configuration 201. The rotary shells 203, 204 of the indirect rotary kilns 200 are made of heat insulating materials, preferably heat resistance concrete and fire bricks.

During operation, the rotary shells 203, 204 rotate in anti-clockwise fashion at a predetermined rotation speed. In one embodiment, the predetermined rotation speed is in the range of 0.2-1 revolution per minute. The rotary shells 203, 204 comprise baffles 205, 206 to lift the content in the reactor cavities 207, 208. The high temperature heating media is flown inside the heating tubes 209, 210, 211, 212, 213 to heat up the contents in the reactor cavities 207, 208 being outside of the heating tubes 209, 210, 211, 212, 213. The high temperature heating media can also heat up the activation agent inside the activation agent injection pipes 214, 215, 216, 217, 218 that are positioned inside the heating tubes 209, 210, 211, 212, 213. The heated activation agent then enters the reaction cavities 207, 208 via the activation agent injection pipe openings 219-238 that are located on the heating tubes 209, 210, 211, 212, 213. The activation agent is used for activating the contents in the reactor cavities 207, 208.

Referring back to FIG. 2, during operation, only the rotary shells 203, 204 rotate while the heating tubes 209, 210, 211, 212, 213 and the activation agent injection pipes 214, 215, 216, 217, 218 remain stationary. This operation includes the devolatilization/carbonization of the bamboo scaffolding waste, waste wooden pallets and the like, activation of the char, and cooling of the indirect rotary kiln. The indirect rotary kiln is further characterized in having the centerline of the heating tubes 209, 210, 211, 212, 213 located below the centerline of the indirect rotary kiln. Such configuration helps to increase the contact between the content inside the reactor cavities 207, 208 and the hot surface of the heating tubes 209, 210, 211, 212, 213.

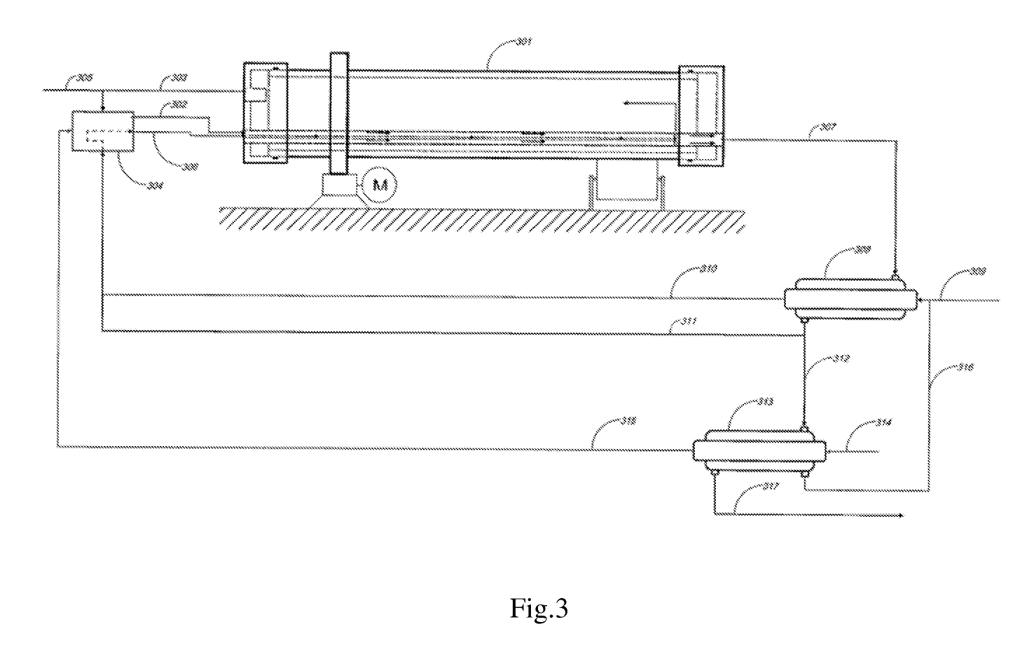

FIG. 3 shows a schematic diagram of a method for production of activated carbon using a reactor according to one of the preferred embodiments of the present invention. Feedstock comprising bamboo scaffolding waste, waste wooden pallets and the like are first loaded into an indirect rotary kiln 301. In one embodiment, the indirect rotary kiln 301 is previously described in FIGS. 1 and 2. Upon loading, the indirect rotary kiln 301 starts rotating and the content of the bamboo scaffolding waste, waste wooden pallets and the like inside the indirect rotary kiln 301 is heated by high temperature media, which is fed to a heating tube of the indirect rotary kiln 301 via a first pipeline 302. In one embodiment, the high temperature media is at a temperature of above 1000° C.

When the temperature inside the indirect rotary kiln 301 continues to rise, the bamboo scaffolding waste, waste wooden pallets and the like devolatilize to evolve volatile matters and to form char. The second portion of the volatile matters is directed out of the indirect rotary kiln 301 to a furnace 304 via a second pipeline 303 for combustion. Prior to the delivery of the second portion of the volatile matters to the furnace 304, fuel is delivered to the furnace 304 via a third pipeline 305 for combustion to generate the high temperature media or heat for heating the high temperature media. The high temperature media, in one embodiment, is preferably the flue gas of combustion. Once the high temperature media generated from the second portion of the volatile matters is sufficient to sustain the continuous increment of the temperature inside the indirect rotary kiln 301, the supply of the fuel to the furnace 304 via the third pipeline 305 is stopped. The amount of the second portion of the volatile matters delivered to the furnace is regulated to ensure that a steady increase in the temperature of the indirect rotary kiln 301.

The first portion of the volatile matters is intentionally trapped within the indirect rotary kiln 301 and reserved for further reactions in increasing the yield of char from the carbonization process, so as to increase the final yield of activated carbon.

When the temperature inside the indirect rotary kiln 301 reaches a fourth predetermined temperature, which is preferably with in the range of 750-800° C., high temperature activation agent is injected into an activation agent injection pipe of the indirect rotary kiln 301 via a fourth pipeline 306. The activation agent is further heated inside the indirect rotary kiln 301 by the high temperature media before contacting with the contents inside the indirect rotary kiln 301. Upon contact, the activation agent activates the contents inside the indirect rotary kiln 301; during activation, the high temperature activation agent reacts with char to generate synthesis gas. In one embodiment, the synthesis gas comprises methane, carbon monoxide, carbon dioxide, and short chain hydrocarbons. The synthesis gas is then mixed with the first portion of the volatile matters trapped in the indirect rotary kiln 301 to increase the heating value of the synthesis gas and at the same time, decrease the lower explosive limit and the auto ignition temperature of the synthesis gas. The mixture is then burnt in the furnace 304 for producing energy to sustain the activation process. The trapping of the mixture of synthesis gas and the first portion of the volatile matters within the indirect rotary kiln 301 helps to resolve the problem encountered in conventional indirect rotary kiln that it is often difficult to bring the synthesis gas generated from the activation process into combustion.

The high temperature media leaves the indirect rotary kiln 301 via a fifth pipeline 307 into a first heat exchanger 308. As the temperature of the high temperature media is still very high, preferably above 800° C., the high temperature media is used to produce and/or heat up the activation agent. The activation agent, which is water in one embodiment, is fed to the first heat exchanger 308 via a twelfth pipeline 309 wherein heat between the activation agent and the high temperature media is indirectly exchanged within the first heat exchanger 308. The activation agent is turned into superheated activation agent in the heat exchanger 308. The temperature of the superheated activation agent, expected to be higher than 200° C., is delivered to the furnace 304 via a sixth pipeline 310 for further indirect heating, before being delivered back to the indirect rotary kiln 301 via the fourth pipeline 306. After the indirect exchange of heat with the activation agent in the first heat exchanger 308, the high temperature media is delivered out of the first heat exchanger 308 and directed to a seventh pipeline 311 and an eighth pipeline 312. As the high temperature media is preferably combustion flue gas, the high temperature media comprises a plurality of good activation agents that can be used for activation of the char inside the indirect rotary kiln 301. In one embodiment, the good activation agents comprise water vapor, carbon dioxide, oxygen, and carbon monoxide. Due to the presence of the good activation agents in the high temperature media, part of the high temperature media is mixed with the superheated activation agent in the sixth pipeline 310 via the seventh pipeline 311 in order to further increase the temperature of the activation agent prior to being superheated in the furnace 304.

Most of the high temperature media, preferably accounting for over 95 weight percent of the high temperature media, is directed to the eighth pipeline 312 for further heat exchange in a second heat exchanger 313 wherein heat is indirectly exchanged between the high temperature media and combustion air used for combustion in the furnace 304. The combustion air is fed into the second heat exchanger 313 via a ninth pipeline 314 and heated therein at temperature preferably in the range of 150-200° C. The combustion air is then delivered to the furnace 304 for combustion via a thirteenth pipeline 315. During the heat exchange in the second heat exchanger 313, the temperature of the high temperature media drops and condensates of the activation agent can be collected in the heat exchange process due to the high content of the activation agent in the high temperature media. Upon collection, the condensates of the activation agent can be fed into the first heat exchanger 308 via a tenth pipeline 316 for superheating. In one embodiment, the condensates are mainly water while the activation agent is preferably water, water vapor or steam. After passing through the second heat exchanger 313, the high temperature media, preferably flue gas, is directed to a tenth pipeline 317 for further treatment or discharge.

When the temperature inside the indirect rotary kiln 301 reaches an activation completion temperature for an activation duration, the activation process is completed. In one embodiment, the activation completion temperature is in the range of 800-1000° C. while the activation duration is in the range of 0.5-4 hours respectively. The pressure of the indirect rotary kiln 301 is then allowed to settle to atmospheric pressure and thus, most of the synthesis gas and the volatile matters trapped inside the indirect rotary kiln 301 are displaced by the high temperature activation agent. Room temperature air is then directed into the heating tube of the indirect rotary kiln 301 via the first pipeline 302 for cooling the contents inside the indirect rotary kiln 301. When the temperature inside the indirect rotary kiln 301 reaches a room-temperature-air injection temperature, the room temperature air can also be directly injected into the activation agent injection pipe of the indirect rotary kiln 301 via the fourth pipeline 306. In one embodiment, the room temperature air injection temperature is preferably in the range of room temperature to 300° C. During the cooling process, the rotary shell of the indirect rotary kiln 301 keeps rotating so as to speed up the cooling process by increasing the heat transfer rate. When the temperature of the indirect rotary kiln 301 drops below 150° C., the activated carbon inside the indirect rotary kiln 301 can be unloaded for product storage.

The invention is exemplified by the following non-limiting examples.

### EXAMPLE I

20 tons of bamboo scaffolding waste are fed into the system described in FIG. 3. The diameter and the length of the rotary shell of the indirect rotary kiln 301 are 2 meters and 10 meters respectively. The rotational speed of the rotary kiln 301 is 0.2 revolution per minute. Water was used as the activation agent. 75 kg of fuel was used to initiate the devolatilization of the bamboo scaffolding waste. Once the devolatilization is initiated, no additional fuel is required.

Water is fed into the first heat exchanger 308 via the twelfth pipeline 309 when the temperature inside the indirect rotary kiln 301 reaches 750° C. The temperature of the activation agent inside the fourth pipeline 306 is regulated at 750° C. while the temperature of the indirect rotary kiln 301 is kept at 900° C. for 2 hours. Then, the indirect rotary kiln 301 is cooled down and the yield of the activated carbon generated as well as the BET surface area of the generated activated carbon are analyzed. From the analysis, the yield of the activated carbon is 22.3% and the average BET surface area is 943 m²/g with standard deviation of 83.2 m²/g.

The yield of activated carbon generated from conventional process and the average BET surface area of the generated activated carbon are 15% and 900 m²/g respectively. Thus, from the results, both the yield and the BET surface area using the system and method of this invention is higher than those of the conventional processes.

The standard deviation of the BET surface area varies depending on the type of the conventional process used. Yet, the standard deviation of the BET surface area of the present invention should be classified as small on compared with conventional processes.

### EXAMPLE II

The process described in Example I is repeated in which bamboo scaffolding waste is replaced with waste wooden pallet as feedstock. The yield of the activated carbon generated thereof is 25.8% and the average BET surface area is 843 m²/g with standard deviation of 45.7 m²/g.

Thus, from the results, the yield of the activated carbon generated from the system and method of this invention is higher than those of the conventional processes.

### EXAMPLE III

The process described in Example I is repeated in which the activation agent is changed from water to 5% of the combustion flue gas. The yield of the activated carbon generated thereof is 26.7% and the average BET surface area is 1207 m²/g with standard deviation of 97.4 m²/g.

Thus, from the results, both the yield and the BET surface area using the system and method of this invention is higher than those of the conventional processes.

As aforementioned, the combustion flue gas comprises carbon dioxide and carbon monoxide. There is a chance for carbon dioxide and carbon monoxide to convert back to elementary carbon and in that case, the yield of this Example would be even higher than that of Example I.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. An indirect rotary kiln for the production of activated carbon from feedstock, wherein said indirect rotary kiln comprises
a) a rotary shell comprising a reactor cavity created therewithin;
b) at least one heating tube adapted to be fixedly positioned inside said rotary shell; and
c) at least one activation agent injection pipe adapted to be fixedly positioned within said heating tube;
wherein a first portion of a first devolatilization product is adapted to retain within said kiln for further mixing and reacting with synthesis gas produced from activation of a second devolatilization product to supply heat for said devolatilization.

2. The indirect rotary kiln of claim 1 wherein a second portion of said first devolatilization product is adapted to be directed out of said kiln to a furnace to supply heat for said devolatilization.

3. The indirect rotary kiln of claim 1 wherein said heating tube comprises at least one activation agent injection pipe opening located thereon.

4. The indirect rotary kiln of claim 1 wherein said rotary shell further comprises at least one feedstock opening at each end thereof for loading said feedstock into said reactor cavity.

5. The indirect rotary kiln of claim 1 wherein said heating tube comprises at least one tube opening at each end of said heating tube; high temperature media is adapted to flow through said heating tube via said tube opening for heating said feedstock within said indirect rotary kiln.

6. The indirect rotary kiln of claim 1 wherein said activation agent injection pipe comprises at least one pipe opening at one end of said activation agent injection pipe, and at least one activation agent outlet at the other end of said activation agent injection pipe; activation agent is adapted to be injected into said activation agent injection pipe at said pipe opening, and injected out of said activation agent injection pipe into said reactor cavity for activating said feedstock.

7. The indirect rotary kiln of claim 1 wherein said feedstock comprises bamboo scaffolding waste and waste wooden pallet; said reaction product comprises volatile matters and char; said activation agent comprises water, water vapor, carbon dioxide, oxygen, and carbon monoxide.

8. The indirect rotary kiln of claim 1 wherein said rotary shell is made of material with good insulation property such that the temperature of said indirect rotary kiln can be maintained at a desirable temperature.

9. The indirect rotary kiln of claim 8 wherein said material with good insulation property is selected from a group consisting of heat resistance concrete and fire bricks.

10. The indirect rotary kiln of claim 1 comprising one heating tube and one activation agent injection pipe.

11. The indirect rotary kiln of claim 1 comprising four heating tubes and four activation agent injection pipes.

12. The indirect rotary kiln of claim 1 further comprising a plurality of baffles adapted to lift the content within said indirect rotary kiln.

13. The indirect rotary kiln of claim 1 wherein the centerline of said stationary heating tube is below the centerline of said rotary shell.

14. A method for production of activated carbon with high quality from feedstock, wherein said method comprises the steps of:
a) providing an indirect rotary kiln of claim 1;
b) loading said feedstock into said indirect rotary kiln;
c) rotating said rotary shell;
d) flowing high temperature media into said heating tube for heating and devolatilizing said feedstock;
e) retaining said first portion of said first devolatilization product trapped inside said indirect rotary kiln for further reactions;
f) injecting an activation agent into said indirect rotary kiln for activating char produced from said carbonization process to generate synthesis gas, when the temperature of said indirect rotary kiln reaches an activation agent injection temperature;
g) mixing said synthesis gas produced in said activation process with said first portion of said first devolatilization product inside said indirect rotary kiln;
h) delivering said mixture of step (g) into said furnace for combustion;
i) completing said activation process when the temperature of said indirect rotary kiln reaches an activation completion temperature for an activation duration; and
j) cooling said indirect rotary kiln by passing room temperature air into said heating tube; and
wherein said combustion in step (h) generates sufficient heat and energy to sustain said activation process in step (f); said indirect rotary kiln is further cooled by injecting said room temperature air into said activation agent injection pipe of said indirect rotary kiln through said activation agent injection pipe prior to the stop of the rotation of said indirect rotary kiln for unloading of activated carbon with high quality.

15. The method of claim 14 wherein said step (f) further comprises the step of directing said second portion of said first devolatilization product out of said indirect rotary kiln to a furnace for combustion to produce said high temperature media.

16. The method of claim 14 wherein said activation agent injection temperature is in the range of 750-800° C.; said activation completion temperature is in the range of 800-1000° C.; and said activation duration is 0.5-4 hours.

17. The method of claim 14 wherein said synthesis gas comprises methane, carbon monoxide, carbon dioxide, and short chain hydrocarbons.

18. The method of claim 14 wherein said activation agent comprises water, water vapor, carbon dioxide, oxygen, and carbon monoxide.

19. The method of claim 14 wherein said high temperature media is combustion flue gas.

20. The method of claim 14 comprising a further step of heating said activation agent by said high temperature media.

21. The method of claim 20 wherein said heating of activation agent is carried out insides at least one heat exchanger.
